(19) United States
(12) Patent Application Publication
(10) Pub. No.: US 2021/0017973 A1
(43) Pub. Date: Jan. 21, 2021

(54) COOLANT COMPRESSOR

(71) Applicant: SECOP GMBH, Flensburg (DE)

(72) Inventor: REINHARD RESCH, FELDBACH (AT)

(21) Appl. No.: 15/577,213

(22) PCT Filed: Feb. 29, 2016
(86) PCT No.: PCT/EP2016/054233

§ 371 Date: Nov. 21, 2019

(30) Foreign Application Priority Data
May 27, 2015 (AT) GM 50098/2015

(51) Int. Cl. F04B 39/00; F16F 15/08

(52) U.S. Cl. CPC F04B 39/0044; F04B 39/12; F16F 15/08

(57) ABSTRACT

The invention relates to a refrigerant compressor (1) comprising a hermetically sealed housing (2) and a drive unit which is arranged inside the housing (2) and has a piston-cylinder unit for the cyclical compression of a refrigerant, and an electric motor for driving the piston-cylinder unit, wherein the refrigerant compressor (1) also comprises at least one connection component (4) for attaching the housing (2) to a device in operative connection with the refrigerant compressor (1), preferably to a mounting plate (28) of a cooling device (3), wherein the connection component (4) comprises an inner element (5) and an outer element (6) surrounding the inner element (5), wherein the inner element (5) has a higher rigidity than the outer element (6). According to the invention, recesses (8) are provided in the outer element (6), which run in transverse directions (27), wherein the transverse directions (27) are directed from an outer surrounding surface (26) of the outer element (6) to the inner element (5).

### FIELD OF THE INVENTION

The present invention relates to a refrigerant compressor comprising a hermetically sealed housing and a drive unit arranged in the interior of the housing, comprising a piston-cylinder unit for cyclical compression of a refrigerant and an electric motor for driving the piston-cylinder unit, wherein the refrigerant compressor additionally comprises at least one connecting component for connecting the housing to a device operatively connected to the refrigerant compressor, preferably a mounting plate of a refrigerating appliance, wherein the connecting component comprises an inner element and an outer element surrounding the inner element, wherein the inner element has a higher rigidity than the outer element.

### Prior Art

According to the prior art, connecting components are used for vibrational decoupling of a refrigerant compressor from a device, particularly a refrigerating appliance, that is operatively connected to the refrigerant compressor. A housing of the refrigerant compressor is linked to or connected to the device via the connecting components. The connecting components typically comprise a sleeve, more particularly made from metal, which is surrounded radially by a rubber element having a typical Shore A hardness of 40-50.

Rubber has a number of disadvantages that negatively influence the vibrational decoupling, particularly under transverse stress on the connecting components. Particularly the high dynamic rigidity of rubber and the incompressibility thereof, in conjunction with the type of installation, which causes a high transverse rigidity of the connecting component, makes sufficiently good vibrational decoupling nearly impossible, especially at low frequencies.

Rubber is used nevertheless for reasons of cost. Particularly for mass-produced goods such as refrigerating appliances, the cost pressure is extremely high, and therefore rubber is preferably used as the material.

### Problem of the Invention

The problem addressed by the invention is therefore that of providing a refrigerant compressor having a connecting component that allows improved vibrational decoupling between the refrigerant compressor and the device operatively connected to the refrigerant compressor. In particular, the connecting component according to the invention should create the possibility of using inexpensive materials and nevertheless achieving the same or at least approximately the same properties as those of connecting components in which more expensive materials are installed.

### Presentation of the Invention

The core of the invention for solving the above-mentioned problem, for a connecting component of a refrigerant compressor that has an inner element and an outer element surrounding the inner element, is a reduction of the dynamic rigidity of the outer element and of the transverse rigidity of the connecting component as a whole in a targeted manner by suitable geometrical design of the connecting component in order to allow improved vibrational decoupling. In a refrigerant compressor comprising a hermetically sealed housing and a drive unit arranged in the interior of the housing, comprising a piston-cylinder unit for cyclical compression of a refrigerant and an electric motor for driving the piston-cylinder unit, wherein the refrigerant compressor additionally comprises at least one connecting component for connecting the housing to a device operatively connected to the refrigerant compressor, preferably a mounting plate of a refrigerating appliance, wherein the connecting component comprises an inner element and an outer element surrounding the inner element, wherein the inner element has a higher rigidity than the outer element, it is therefore provided according to the invention that recesses run in transverse directions in the outer element, wherein the transverse directions point from an outer envelope surface of the outer element to the inner element. The outer envelope surface of the outer element can be an outer surface of the outer element or a surface enveloping the outer surface.

For viscoelastic materials such as rubber, the form factor determines the effective rigidity of the component alongside material properties such as the Shore hardness. The recesses effect an enlargement of the free surface area of the outer element and thus reduce the form factor thereof, without substantially increasing compressive strains and thus causing subsidence of the outer element. The form factor is determined by the ratio between the force-introduction surface and the free surface. This results in a reduced dynamic rigidity of the outer element. A reduction of the form factor again causes a reduction of the dynamic rigidity.

It should be noted that the shearing deformability of the outer element can be better utilized for vibrational decoupling due to the recesses.

For easy production of the recesses, a preferred embodiment of the refrigerant compressor according to the invention provides that the recesses are formed as slots. In order to shape the free surface to be particularly large, it is provided according to a preferred embodiment of the refrigerant compressor according to the invention that the recesses pass through the entire outer element in an axial direction. The axial direction is the direction in which the connecting component is under compressive stress. A longitudinal axis of the connecting component is preferably parallel to the axial direction. In order to allow a particularly easy production of the recesses, a preferred embodiment of the refrigerant compressor according to the invention provides that the recesses are open towards the outside. In this case, the outer surface of the outer element does not coincide with the envelope surface thereof, but is instead enveloped by the envelope surface. The recesses are preferably delimited towards the inside by the outer surface of the outer element. The recesses are preferably open towards the outside parallel to the transverse directions.

In order to avoid undesired directional dependencies of the dynamic rigidity of the outer element, a preferred embodiment of the refrigerant compressor according to the invention provides that the recesses are arranged regularly about the longitudinal axis of the connecting component, preferably at an identical angular distance from one another. In particular, this regular arrangement points in a section plane perpendicular to the longitudinal axis, wherein the longitudinal axis preferably runs parallel to the axial direction, as already mentioned.

It has been shown in extensive tests that an especially uniform response of the connecting component to stresses, particularly those transverse to the axial direction, can be achieved if the angular spacing between the recesses can be kept within a range between 3° and 45°. A preferred embodiment of the refrigerant compressor according to the invention accordingly provides that the recesses have an angular spacing of 3° to 45°, preferably 5° to 30°, from one another.

In general, the specified limit values of intervals/regions are to be understood as belonging to the respective interval/region unless otherwise explicitly indicated. A preferred embodiment of the refrigerant compressor according to the invention provides that the recesses each cover an angular region of at least 1° to 10°, preferably 1° to 4°.

A preferred embodiment of the refrigerant compressor according to the invention provides that the connecting component has at least one additional recess, which is arranged between the inner element and the outer element. The at least one additional recess allows better utilization of the shearing deformability of the outer element, because the outer element can deform under a transverse stress in such a manner that parts of the outer element can move into the at least one additional recess. The interaction of the recesses with the at least one additional recess effectively reduces the transverse rigidity of the outer element, or the connecting component, for vibrational decoupling between housing and device.

A preferred embodiment of the refrigerant compressor according to the invention accordingly provides that the at least one additional recess is unoccupied in an unstressed condition of the connecting component and is occupied, at least in certain regions, by the outer element in a stressed condition of the connecting element.

To enable a centered fit, more particularly a centered press-fit, of the outer element on the inner element despite the at least one additional recess, a preferred embodiment of the refrigerant compressor according to the invention provides that the at least one additional recess has an extent in the axial direction that is less than the extent of the outer element in the axial direction. Thus at least a portion of the outer element delimits the at least one additional recess in the axial direction at least from one side and contacts the inner element at this portion.

In a preferred embodiment of the refrigerant compressor according to the invention, a plurality of additional recesses are provided, which are separated from one another by ridges of the outer element in a section plane perpendicular to an axial direction. The ridges ensure a centered fit of the outer element on the inner element over substantially the entire axial extent of the outer element. Embodiment variants are also conceivable in which the recesses extend into the ridges.

In order to lower the transverse rigidity of the connecting component in this case uniformly, i.e. without undesired directional dependence, a preferred embodiment of the refrigerant compressor according to the invention provides that the additional recesses in the section plane are arranged regularly, preferably at an identical angular spacing from one another around a longitudinal axis of the connecting component. As already mentioned, the longitudinal axis preferably runs parallel to the axial direction. It has been shown in extensive tests that a particularly uniform response of the connecting component to stresses transverse to the axial direction can be achieved if the angular spacing between the additional recesses can be kept within a range between 3° and 45°. A preferred embodiment of the refrigerant compressor according to the invention accordingly provides that the additional recesses have an angular spacing of 3° to 45°, preferably 5° to 30°, from one another in the section plane. This angular spacing corresponds to the angular region covered by a respective ridge.

A preferred embodiment of the refrigerant compressor according to the invention provides that the additional recesses each cover an angular region of 10° to 40° in the section plane, in order to guarantee a sufficiently large reduction of the transverse rigidity of the connecting component.

In order to be able to pass a fastening means such as a screw or bolt through the connecting component, a preferred embodiment of the refrigerant compressor according to the invention provides that the inner element has the shape of a sleeve. Thus the connecting component with the fastening means can be connected to the housing or the device, more particularly bolted thereto, in a simple manner. The inner element also prevents the outer element from subsiding when the threaded fastener has been tightened. In order to guarantee an element that is especially stable mechanically and simultaneously easy and economical to produce, a preferred embodiment of the refrigerant compressor according to the invention provides that the inner element is produced from a metal such as steel.

The outer element is preferably elastic and is especially preferably only slightly compressible or even not compressible at all. A preferred embodiment of the refrigerant compressor according to the invention thus provides that the outer element is produced from rubber or an elastomer. Rubber can be produced from a natural material, particularly latex, or a synthetic material. The elastomer is preferably only slightly compressible or even not compressible at all.

Furthermore, a preferred embodiment of the refrigerant compressor according to the invention provides that an attachment foot that surrounds the outer element in a connecting portion of the outer element is provided on the housing for mounting the at least one connecting component. The attachment foot also enables a high flexibility in the positioning of the housing relative to the device.

An especially preferred embodiment of the refrigerant compressor according to the invention provides that the connecting portion overlaps the at least one additional recess in the axial direction. The overlap of the connecting portion with the at least one additional recess ensures that under a stress in the transverse direction, i.e. transverse to the axial direction, the shearing deformability of the outer element is utilized as efficiently as possible and the outer element moves or can move into the at least one additional recess.

To guarantee a long-term defined positioning of the attachment foot, particularly in the axial direction, a preferred embodiment of the refrigerant compressor according to the invention provides that the attachment foot is received in a groove of the outer element. Finally, analogously to that which was stated above, a system is also provided according to the invention, comprising a refrigerant compressor according to the invention and a device, preferably a refrigerating appliance, that is operatively connected to the refrigerant compressor, wherein the device comprises a mounting plate on which the housing of the refrigerant compressor is connected to the at least one connecting component.

### BRIEF DESCRIPTION OF THE FIGURES

The invention will now be explained in detail with reference to embodiments. The drawings are for the sake of example and are intended to present the inventive concept, but by no means to restrict it or exhaustively reproduce it.

Therein:

FIG. 1 shows a side view of a refrigerant compressor according to the invention

FIG. 2 shows a sectional view through a connecting component according to the invention for the refrigerant compressor along the section line A-A in FIG. 1, wherein the arrows indicate the viewing direction

FIG. 3 shows a sectional view of the connecting component according to the invention along the section line B-B in FIG. 2, the arrows indicating the viewing direction

FIG. 4 shows a sectional view like FIG. 3 for an additional embodiment of the component according to the invention

FIG. 5 shows a perspective view of an outer element from FIG. 4

### MEANS FOR EMBODYING THE INVENTION

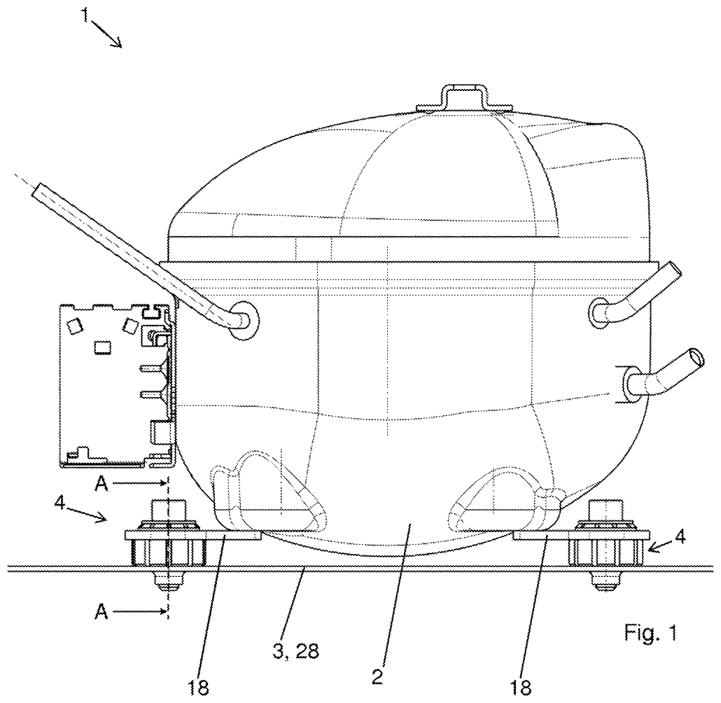

A refrigerant compressor 1 according to the invention, having a housing 2, can be seen in the side view of FIG. 1, wherein a drive unit in the interior of the housing 2 is provided, comprising a piston cylinder unit for cyclical compression of a refrigerant, and an electric motor for driving the piston-cylinder unit (not shown) is provided. The housing 2 is connected by connecting components 4 to a mounting plate 28 of a refrigerating appliance 3, with which the refrigerant compressor 1 has an operative connection. To enable easy positioning of the housing 2 or the refrigerant compressor 1 relative to the refrigerating appliance 3 or the mounting plate 28, the connecting components 4 have attachment feet 18 that are connected to the housing 2.

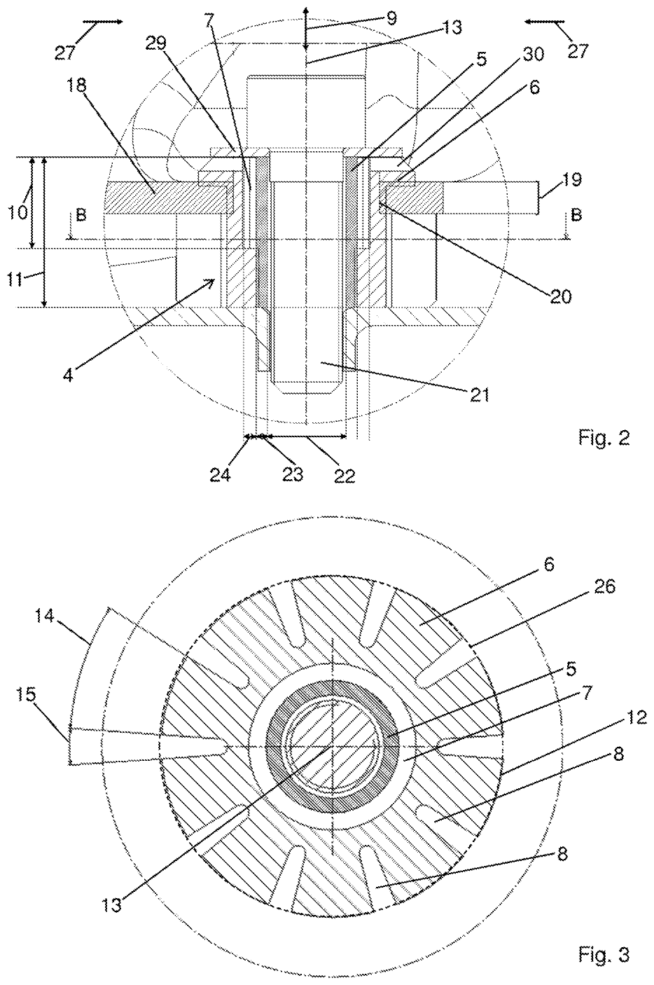

FIG. 2 shows a sectional view through a connecting component 4 according to the invention along the section line A-A in FIG. 1; the arrows indicate the viewing direction and a longitudinal axis 13 of the connecting component 4 lies in the section plane. The connecting component 4 comprises an inner element 5 and an outer element 6 surrounding the inner element 5. The inner element 5 is constructed in a sleeve shape, which allows the passage of a bolt 21, with which bolt 21 the connecting component 4 is secured to the mounting plate 28. A washer 29 is also provided between a head of the bolt 21 and the connecting component 4. The inner element 5 accordingly has a clear internal diameter 22 that allows sufficient space for receiving the bolt 21. For example, the interior diameter 22 can be 6.5 mm to 8.7 mm.

The inner element 5 has an increased rigidity in relation to the outer element 6 and thus prevents subsidence of the outer element 6. For this purpose, the inner element 5 is preferably produced from metal such as steel or stainless steel. A wall thickness 23 of the inner element 5 can be correspondingly thin, for example 0.85 mm to 1.2 mm. The outer element 6 is preferably made from rubber or an elastomer. The outer element 6 preferably has a low compressibility or none at all.

The attachment foot 18 encloses the outer element 6 in a connecting portion 19 of the outer element 6. More particularly, in order to guarantee a defined positioning of the attachment foot 18 in an axial direction 9, the attachment foot 18 is received in a groove 20 of the outer element 6, wherein the groove 20 preferably runs radially. The axial direction 9 is the direction in which the connecting component 4 is under compressive stress. The longitudinal axis 13 of the connecting component 4 is preferably parallel to the axial direction 9.

Under a transverse load, i.e. during a vibration of the housing 2 in transverse directions 27, which are transverse to, preferably perpendicular to, the axial direction 9, the inner element 5 and the attachment foot 18 surrounding the outer element 6 fundamentally limit a shearing deformation of the outer element 6. In particular, a low compressibility or incompressibility of the outer element 6 makes a contribution in this regard. In order nevertheless to realize as low a transverse rigidity of the connecting component 4 as possible, which permits a good vibrational decoupling of the housing 2 from the refrigerating appliance 3, the connecting component 4 has recesses in the form of slots 8. In order to further reduce the transverse rigidity, the connecting component 4 in the embodiments shown also has at least one additional recess 7.

The at least one additional recess 7 is arranged, as viewed in the transverse direction 27, between the inner element 5 and the outer element 6. In the transverse direction 27, the at least one additional recess 7 has an extent 24, which can be 0.5 mm to 2 mm for example. The slots 8 are provided in the outer element 6 and respectively run along the transverse directions 27, wherein the transverse directions 27 are basically directed from an outer envelope surface 26 of the outer element 6 toward the inner element 5. In the embodiment shown, the transverse directions are also directed from the outer envelope surface 26 to a center that is formed by the longitudinal axis 13. That is to say, the slots 8 are arranged outside the inner element 5 as viewed in the transverse direction 27. As is clear in the sectional view of FIG. 3, the slots 8 in the embodiment shown are also arranged completely outside of the additional recess 7. In the embodiments shown the slots 8 are open outwards, as viewed parallel to the transverse directions 27. The outer envelope surface 26 is therefore not formed by an outer side 12 of the outer element 6, but instead envelops the outer surface 12. This is easily recognizable in the sectional view of FIG. 3, wherein the envelope surface 26 is shown in dot-dash lines.

The radial slots 8 effect an enlargement of the free surface area of the outer element 6 and thus reduce the form factor thereof, without increasing compressive strains and thus subsidence of the outer element 6. The form factor is determined by the ratio between the force-introduction surface and the free surface. The reduced form factor reduces the dynamic rigidity of the outer element 6 and therefore that of the connecting component 4. The at least one additional recess 7 in turn allows better utilization of the shearing deformability of the outer element 6, because the outer element 6 can deform under a transverse stress in such a manner that parts of the outer element 6 can move into the at least one additional recess 7. That is to say, the at least one additional recess 7 is unoccupied in an unstressed state of the connecting component 4 and is occupied at least in certain regions by the outer element 6 in a stressed state (not shown).

The interaction of the slots 8 with the at least one additional recess 7 effectively reduces the transverse rigidity of the outer element 6, or the connecting component 4 for vibrational decoupling between housing 2 and refrigeration appliance 3.

As is evident in FIG. 2, the at least one additional recess 7 has an axial extent 10 in the axial direction 9 that is less than the axial extent 11 of the outer element 6 in the axial direction 9. The outer element 6 can therefore be held in a press-fit on the inner element 5 without problems.

The slots 8, on the other hand, pass through the outer element 6 along the entire axial extent 11 thereof, in order to maximize the free surface area of the outer element 6. The radial slots 8 effect an enlargement of the free surface area of the outer element 6 and thus reduce the form factor thereof, without substantially increasing compressive strains and thus subsidence of the outer element 6.

In the section plane shown in FIG. 3, which is perpendicular to the axial direction 9 or the axial longitudinal axis 13, the slots 8 are arranged regularly about the longitudinal axis 13 in order not to produce any undesired directional dependence (parallel to the transverse directions 27) of the dynamic rigidity of the outer element 6. In a rotational direction about the longitudinal axis 13, each two immediately successive slots 8 always have the same angular spacing 14, which is typically between 3° and 45° and preferably between 5° and 30°. In the embodiment of FIG. 3, the angular spacing 14 is approximately 28°.

Each slot 8 covers an angular region 15 which is typically between 1° and 10°, preferably between 1° and 4°. In the embodiment of FIG. 3, the angular region 15 is approximately 8°. Overall, ten radial slots 8 are present in the embodiment of FIG. 3. The boundary values of the indicated intervals are always to be understood as belonging to the intervals.

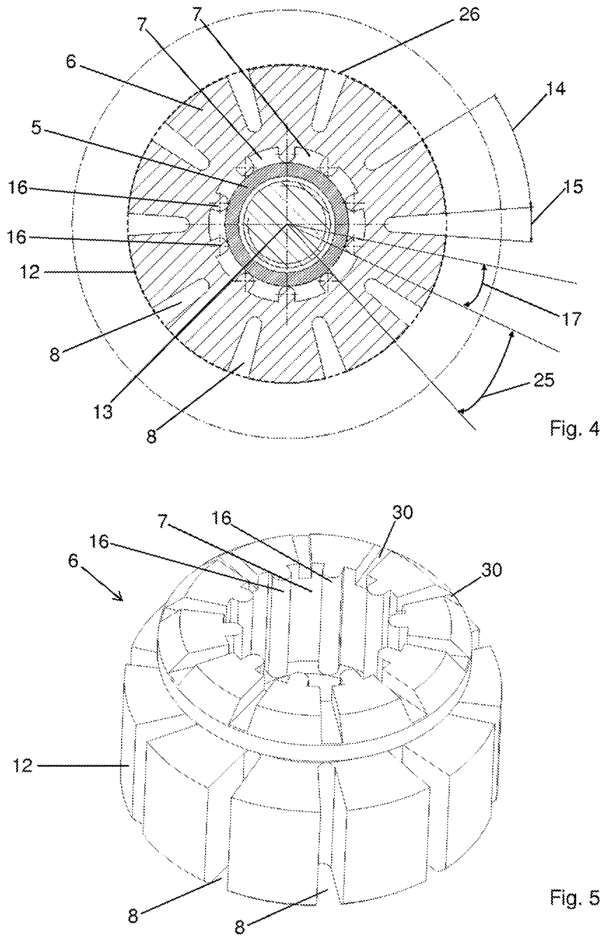

FIG. 4 shows a sectional view corresponding to FIG. 3 of a connecting component 4 in an additional embodiment of the refrigerant compressor 1 according to the invention. In contrast to the embodiment of FIG. 3, multiple, specifically ten additional recesses 7, which are arranged on a circle around the longitudinal axis 13, are provided in the embodiment of FIG. 4. Each two successive additional recesses 7 are separated by a ridge 16 of the outer element 6. The outer element 6 contacts the inner element 5 with the ridges 16, which guarantees a particularly stable centered arrangement of the outer element 6 relative to the inner element 5 without an excessive transverse rigidity. In order not to cause any undesired directional dependence of the transverse rigidity, the additional recesses 7 are arranged regularly around the longitudinal axis 13, wherein an angular spacing 17 of each two successive additional recess is 7 is constant. The angular spacing 17 is typically between 3° and 45°. In the embodiment of FIG. 4, the angular spacing 17 is approximately 9°. The angular spacing 17 clearly corresponds to an angular region that is covered by one ridge 16 in each case. Each additional recess 7 in turn covers an angular region 25 that is typically between 10° and 40°. With very narrow ridges 16, however, it would be quite conceivable to also provide an angular region 25 of less than 10°, because a larger number of ridges 16 is possible or necessary for the centering in this case. In the embodiment of FIG. 4, the angular region 25 is approximately 36°.

In the axonometric view of FIG. 5, it is recognizable that an axial end of the outer element 6 has additional recesses 30, which are also recognizable in FIG. 2. These additional recesses 30 are open towards the top in the axial direction 9 and likewise increase the free surface area of the element 6, which further reduces the dynamic rigidity of the outer element 6.

### LIST OF REFERENCE NUMBERS

1 Refrigerant compressor
2 Housing
3 Refrigerating appliance
4 Connecting component
5 Inner element
6 Outer element
7 Additional recess
8 Slot
9 Axial direction
10 Axial extent of the additional recess
11 Axial extent of the outer element
12 Longitudinal extent of the outer element
13 Longitudinal axis of the connecting component
14 Angular spacing of slots
15 Angular region covered by a slot
16 Ridge
17 Angular spacing of additional recesses
18 Attachment foot
19 Connecting portion of the outer element
20 Groove of the outer element for receiving the attachment foot
21 Bolt
22 Internal diameter of the inner element
23 Wall thickness of the inner element
24 Extent of the additional recess in the transverse direction
25 Angular region covered by an additional recess
26 Outer envelope surface of the outer element
27 Transverse direction
28 Mounting plate
29 Washer
30 Additional recess

1. Refrigerant compressor (1) comprising a hermetically sealed housing (2) and a drive unit arranged in the interior of the housing (2), comprising a piston-cylinder unit for cyclical compression of a refrigerant and an electric motor for driving the piston-cylinder unit, wherein the refrigerant compressor (1) additionally comprises at least one connecting component (4) for connecting the housing (2) to a device operatively connected to the refrigerant compressor (1), preferably a mounting plate (28) of a refrigeration appliance (3), wherein the connecting component (4) comprises an inner element (5) and an outer element (6) surrounding the inner element (5), wherein the inner element (5) has a higher rigidity than the outer element (6), characterized in that recesses (8) running in transverse directions (27) are provided in the outer element (6), wherein the transverse directions (27) are directed from an outer envelope surface (26) of the outer element (6) to the inner element (5).

2. Refrigerant compressor (1) according to claim 1, characterized in that the recesses are constructed as slots (8).

3. Refrigerant compressor (1) according to one of claims 1 to 2, characterized in that the recesses (8) pass through the entire outer element (6) in an axial direction (9).

4. Refrigerant compressor (1) according to one of claims 1 to 3, characterized in that the recesses (8) are open to the outside.

5. Refrigerant compressor (1) according to one of claims 1 to 4, characterized in that the recesses (8) are arranged regularly, preferably with an equal angular spacing (14) from one another, about a longitudinal axis (13) of the connecting component (4).

6. Refrigerant compressor (1) according to claim 5, characterized in that the recesses (8) have an angular spacing (14) from one another of 3° to 45°, preferably 5° to 30°.

7. Refrigerant compressor (1) according to one of claims 5 to 6, characterized in that the recesses (8) respectively cover an angular region (15) of 1° to 10°, preferably 1° to 4°.

8. Refrigerant compressor (1) according to one of claims 1 to 7, characterized in that the connecting component (4) has at least one additional recess (7), which is arranged between the inner element (5) and the outer element (6).

9. Refrigerant compressor (1) according to claim 8, characterized in that the at least one additional recess (7) has an extent (10) in an axial direction (9) that is smaller than an extent (11) of the outer element (6) in the axial direction (9).

10. Refrigerant compressor (1) according to one of claims 8 to 9, characterized in that a plurality of additional recesses (7) are provided, which are separated from one another by ridges (16) of the outer element (6) in a section plane perpendicular to an axial direction (9).

11. Refrigerant compressor (1) according to claim 10, characterized in that the additional recesses (7) are arranged in the section plane regularly, preferably with an identical angular spacing (17) from one another, about a longitudinal axis (13) of the connecting component (4).

12. Refrigerant compressor (1) according to claim 11, characterized in that the additional recesses (7) have an angular spacing (17) of 3° to 45°, preferably 5° to 30°, from one another in the section plane.

13. Refrigerant compressor (1) according to one of claims 11 to 12, characterized in that the additional recesses (7) in the section plane each cover an angular region (25) of 10° to 40°.

14. Refrigerant compressor (1) according to one of claims 8 to 13, characterized in that the at least one additional recess (7) is unoccupied in an unstressed condition of the connecting component (4) and is occupied at least in certain regions by the outer element (6) in a stressed condition of the connecting element (4).

15. Refrigerant compressor (1) according to one of claims 1 to 14, characterized in that the inner element (5) is formed in a sleeve-like shape.

16. Refrigerant compressor (1) according to one of claims 1 to 15, characterized in that the inner element (5) is produced from metal.

17. Refrigerant compressor (1) according to one of claims 1 to 16, characterized in that the outer element (6) is produced from rubber or an elastomer.

18. Refrigerant compressor (1) according to one of claims 1 to 17, characterized in that an attachment foot (18) that surrounds the outer element (6) in a connecting portion (19) of the outer element (6) is provided on the housing (2) for mounting the at least one connecting component (4).

19. Refrigerant compressor (1) according to claim 18, insofar as dependent on one of claims 8 to 14, characterized in that the connecting portion (19) overlaps the at least one additional recess (7) in the axial direction (9).

20. Refrigerant compressor (1) according to one of claims 18 to 19, characterized in that the attachment foot (18) is received in a groove (20) of the outer element (6).

21. System, comprising a refrigerant compressor (1) according to one of claims 1 to 20, and a device, preferably a refrigerating appliance (3), operatively connected to the refrigerant compressor (1), wherein the device comprises a mounting plate (28), to which the housing (2) of the refrigerant compressor (1) is connected by the at least one connecting component (4).
